(19) United States
(12) Patent Application Publication
(10) Pub. No.: US 2019/0322217 A1
(43) Pub. Date: Oct. 24, 2019

(54) VEHICLE PERIPHERY DISPLAY DEVICE

(71) Applicant: SHARP KABUSHIKI KAISHA, Sakai City (JP)

(72) Inventors: HIRONORI TANAKA, Sakai City (JP); KIMIHIRO HYOHDOH, Sakai City (JP); KAZUYUKI HORINOUCHI, Sakai City (JP); SATORU TAKANO, Sakai City (JP)

(21) Appl. No.: 16/359,651

(22) Filed: Mar. 20, 2019

(30) Foreign Application Priority Data
Apr. 23, 2018 (JP) 2018-082189

(51) Int. Cl. B60R 1/00; H04N 5/262; H04N 5/232; B60R 11/04

(52) U.S. Cl. CPC B60R 1/00; H04N 5/2628; H04N 5/23238; B60R 2011/004; B60R 2300/8046; B60R 2300/105; B60R 2300/802; B60R 11/04

(57) ABSTRACT

A vehicle periphery display device provided in a vehicle has a right imaging unit and a left imaging unit that acquire captured images from the front side to the rear side of the vehicle. The captured images acquired by the right imaging unit and the left imaging unit are processed into display images having a display region that corresponds to the operation status and are displayed on display units within the vehicle. A region of a display image that is generated in a case where a predetermined operation status condition has been established (a case where a direction indicator has been operated, for example) is wider than a region of a display image that is generated in a case where the operation status condition has not been established.

### BACKGROUND

### 1. Field

The present disclosure relates to a vehicle periphery display device that displays an image of an external peripheral region of a vehicle.

### 2. Description of the Related Art

A technique has been proposed in the past in which, when an image of an external peripheral region of a vehicle is displayed on a display unit, the display portion is displayed in an enlarged manner in accordance with the operation status of the vehicle.

For example, Japanese Unexamined Patent Application Publication No. 2016-215726 discloses a vehicle periphery display device that captures a first region (rear-side region) and a second region (front-side region) that are different from each other in an external peripheral region of a vehicle by means of respectively different cameras, and displays these two images on one screen. Furthermore, Japanese Unexamined Patent Application Publication No. 2016-215726 discloses that the second region is displayed in an enlarged manner compared to the first region when a predetermined traveling status is in effect (when a right or left turn is being carried out or when curve traveling is being carried out).

Furthermore, Japanese Unexamined Patent Application Publication No. 2016-124391 discloses that, when an image capturing the rear side of a vehicle is displayed, in a case where the shift position of the vehicle is the reverse position, an imaging range is displayed having an angle of view that is wider than in a case where the shift position is the advance position, and ease of use for the driver is increased.

### SUMMARY

In Japanese Unexamined Patent Application Publication No. 2016-215726, there is an issue in that there is an increase in the number of cameras used because images of the first region and the second region are captured by respectively different cameras. Furthermore, there is also an issue in that the driver experiences a sense of discomfort because the images of the first region and the second region are displayed on one screen (because two different images are displayed on one screen).

Furthermore, Japanese Unexamined Patent Application Publication No. 2016-124391 relates to a technique for displaying an imaging range having an angle of view that is wider when reversing than when advancing, and although ease of use for the driver when reversing can be improved, no consideration is given to ease of use when the vehicle is to make a right or left turn or the like.

The present disclosure takes the aforementioned issues into consideration and provides a vehicle periphery display device that is capable of presenting an image corresponding to the status of a vehicle, with good visibility, without the driver experiencing a sense of discomfort, and without increasing the number of cameras that capture the external peripheral region of the vehicle.

In order to address the aforementioned issues, the present disclosure is a vehicle periphery display device that is provided in a vehicle and includes: an imaging unit that is disposed on at least either one of a left and right side surface of the vehicle, and acquires a captured image of the front side to the rear side of the vehicle; an operation status determination unit that determines the operation status of the vehicle; a display region processing unit that generates, from the captured image, a display image having a display region that corresponds to a determination result produced by the operation status determination unit; and a display unit that displays the display image, in which the display region processing unit implements a region of the display image that is generated in a case where a predetermined operation status condition has been established, as a region having an angle of view that is wider than that of the region of the display image that is generated in a case where the operation status condition has not been established.

### BRIEF DESCRIPTION OF THE DRAWINGS

FIG. 1 is a block diagram depicting a schematic configuration of a vehicle periphery display device according to embodiment 1;

FIG. 2 is a drawing depicting an example of a mounting position for a left imaging unit in a vehicle;

FIG. 3 is a drawing depicting an example of arrangement positions for a right display unit and a left display unit inside the vehicle interior;

FIG. 4 is a flowchart depicting display control processing for a captured image in the vehicle periphery display device of embodiment 1;

FIG. 5 is a drawing depicting a region of a narrow range image that is displayed in a case where an operation status condition has not been established;

FIG. 6 is a drawing depicting a region of a wide range image that is displayed in a case where an operation status condition has been established;

FIG. 7 is a block diagram depicting a schematic configuration of a vehicle periphery display device according to embodiment 2;

FIG. 8 is a drawing depicting an example of arrangement positions for display switching indicators inside the vehicle interior;

FIG. 9 is a flowchart depicting display control processing for a captured image in the vehicle periphery display device of embodiment 2;

FIG. 10 is a drawing depicting an example of a situation in which it is appropriate to switch to a wide range image by means of the display switching indicators; and

FIG. 11 is a drawing depicting an example of a situation in which it is appropriate to switch to a wide range image by means of the display switching indicators.

### DESCRIPTION OF THE EMBODIMENTS

### Embodiment 1

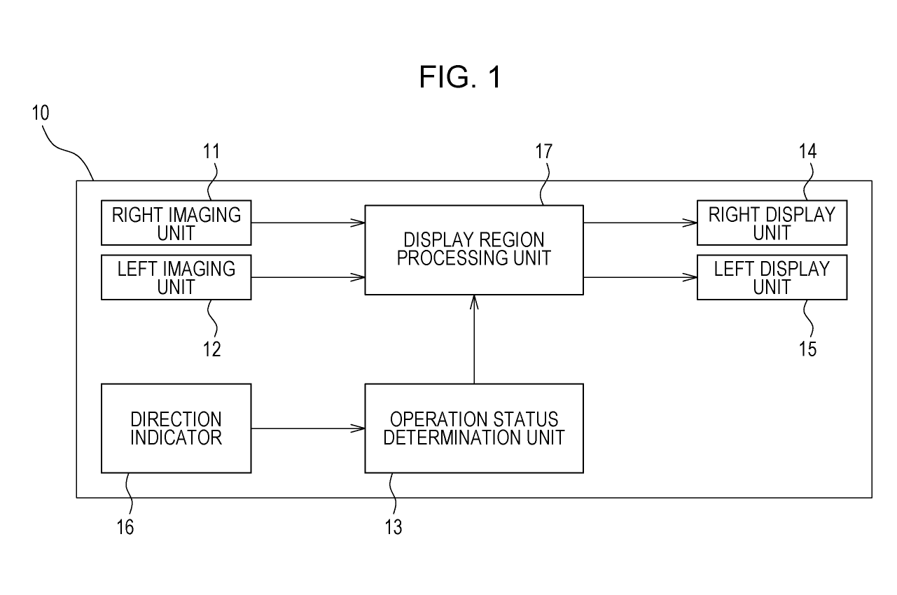

Hereinafter, an embodiment of the present disclosure will be described in detail with reference to the drawings. FIG. 1 is a block diagram depicting a schematic configuration of a vehicle periphery display device 10 according to the present embodiment 1. The vehicle periphery display device 10 includes a right imaging unit 11, a left imaging unit 12, an operation status determination unit 13, a right display unit 14, a left display unit 15, a direction indicator 16, and a display region processing unit 17, or the like.

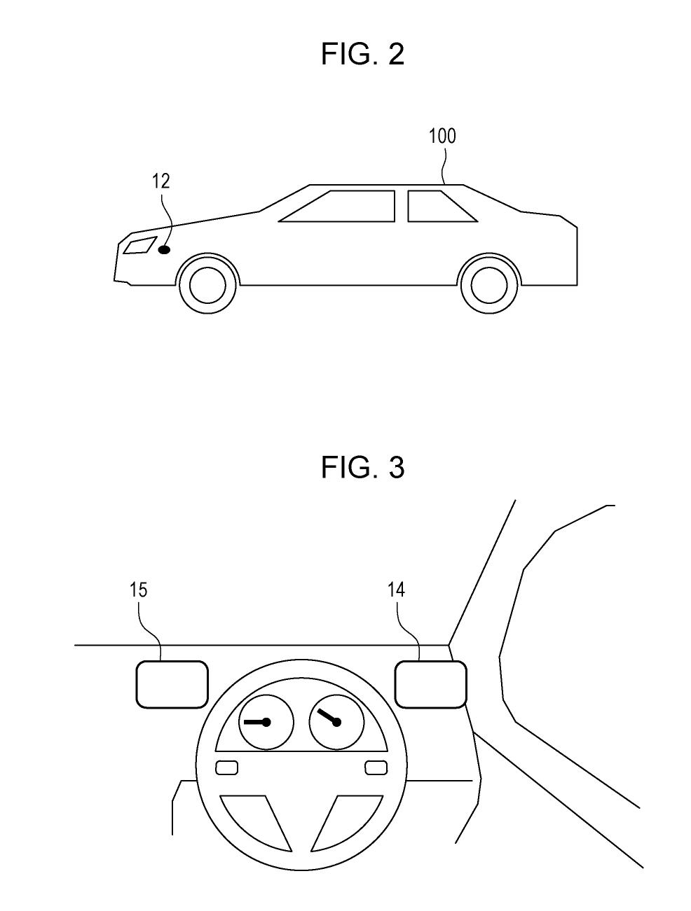

The right imaging unit 11 and the left imaging unit 12 are imaging devices that are capable of capturing an imaging range from the front side to the rear side of a vehicle 100 (see FIGS. 2, 5, and 6), and transmit captured images to the display region processing unit 17. The right imaging unit 11 captures the right side of the vehicle 100, and the left imaging unit 12 captures the left side of the vehicle 100. FIG. 2 is a drawing depicting an example of a mounting position for the left imaging unit 12 in the vehicle 100. The right imaging unit 11 is mounted in a similar position at the right side of the vehicle 100. The right imaging unit 11 and the left imaging unit 12 may be mounted at a front wheel fender position of the vehicle 100, or in front of the front wheel fender position, for example. Note that a front wheel fender in this case indicates an exterior component that covers the upper section of a front wheel of the vehicle 100.

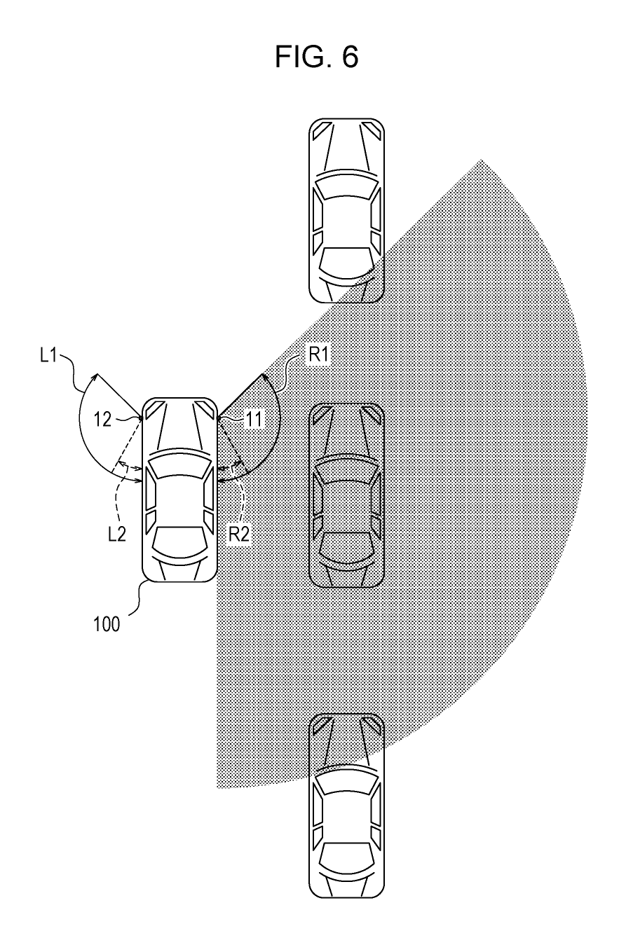

The right imaging unit 11 and the left imaging unit 12 are constituted by imaging elements such as a CMOS (complementary metal-oxide semiconductor), a CCD (charge coupled device), or the like. Furthermore, regions within the ranges of angles of view R1 and L1 seen from above serve as imaging ranges for the right imaging unit 11 and the left imaging unit 12 (see FIG. 6). It is desirable for the imaging elements of the right imaging unit 11 and the left imaging unit 12 to have comparatively high resolutions, and for the lens angle of view to be a wide angle of view of 90° or more. Note that although the lens angle of view of the right imaging unit 11 and the left imaging unit 12 is 140° in the present embodiment 1, the present disclosure is not restricted thereto.

The operation status determination unit 13 determines the operation status of the vehicle 100, and inputs that determination result to the display region processing unit 17. In the present embodiment 1, the operation status determination unit 13 determines the status of the operation of the direction indicator 16 implemented by the driver. More specifically, the operation status determination unit 13 determines whether or not a specific operation status condition has been established.

The display region processing unit 17 carries out image processing that alters a display region, with respect to an image signal (captured image) transmitted from the right imaging unit 11 and/or the left imaging unit 12, in accordance with the determination result from the operation status determination unit 13, and generates a display image. The display region processing unit 17 is constituted by a microcomputer, for example, and executes the aforementioned image processing by executing various types of programs stored in a storage element such as a ROM (read-only memory).

The right display unit 14 and the left display unit 15 display images generated by the display region processing unit 17. The right display unit 14 displays an image of the right side of the vehicle 100, and the left display unit 15 displays an image of the left side of the vehicle 100. The driver is able to confirm the peripheral status of the vehicle 100 without using a general door mirror, fender mirror, or the like by viewing the right display unit 14 and the left display unit 15. FIG. 3 is a drawing depicting an example of arrangement positions for the right display unit 14 and the left display unit 15 inside the vehicle interior. However, the arrangement positions for the right display unit 14 and the left display unit 15 are not restricted provided that the arrangement positions are locations inside the vehicle interior where the right display unit 14 and the left display unit 15 can be easily viewed by the driver.

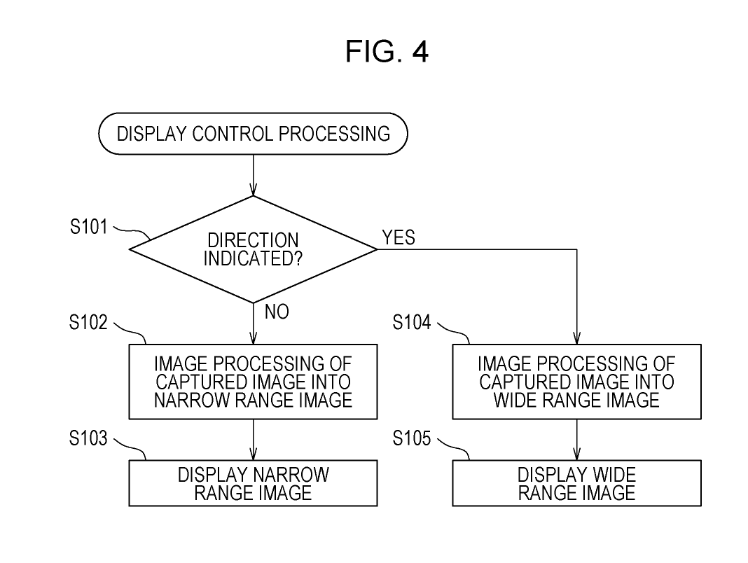

FIG. 4 is a flowchart depicting display control processing in the vehicle periphery display device 10 of the present embodiment 1. As mentioned above, the right imaging unit 11 and the left imaging unit 12 perform imaging with regions within the ranges of the angles of view R1 and L1 serving as imaging ranges, and captured images that correspond to these imaging ranges are input to the display region processing unit 17. The display region processing unit 17 then carries out different image processing with respect to the captured images that are input, in accordance with whether or not a specific operation status condition has been established.

In S101 of FIG. 4, the operation status determination unit 13 determines whether or not the direction indicator 16 has been operated by the driver (whether or not a direction has been indicated). More specifically, the operation status determination unit 13 determines that the specific operation status condition has been established in a case where the direction indicator 16 has been operated. Processing transitions to S102 in a case where the operation status condition has not been established (no in step S101), and processing transitions to S104 in a case where the operation status condition has been established (yes in step S101).

In a case where the operation status condition has not been established, that is, in a case where the vehicle 100 is being driven normally without turning right or left or changing lanes, the display region processing unit 17 carries out image processing that generates a narrow range image from each of the captured images that are input from the right imaging unit 11 and the left imaging unit 12 (S102). The right display unit 14 and the left display unit 15 then respectively display the narrow range images generated by the display region processing unit 17 (S103).

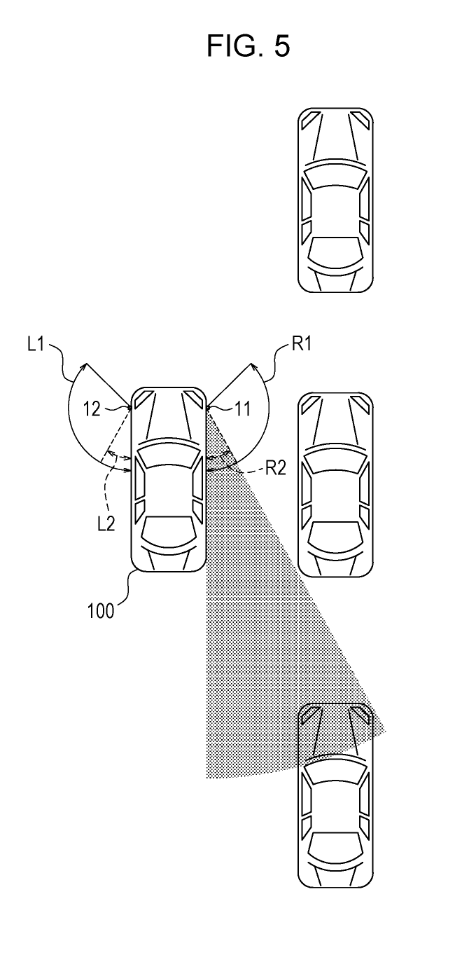

FIG. 5 is a drawing depicting a region of a narrow range image that is displayed in a case where the operation status condition has not been established. More specifically, a narrow range image is an image depicting the rear side of the vehicle 100, and is an image of a region within the ranges of angles of view R2 and L2 which correspond to a general door mirror, fender mirror, or the like. The display region processing unit 17 cuts out images of the ranges of the angles of view R2 and L2 as narrow range images, from the images of the angles of view R1 and L1 captured by the right imaging unit 11 and the left imaging unit 12.

Furthermore, in a case where the operation status condition has been established, that is, in a case where the driver has indicated a direction by means of the direction indicator 16 in order to turn right or left or change lanes, the display region processing unit 17 carries out image processing that generates a wide range image from each of the captured images that are input from the right imaging unit 11 and the left imaging unit 12 (S104). The right display unit 14 and the left display unit 15 then respectively display the wide range images generated by the display region processing unit 17 (S105).

FIG. 6 is a drawing depicting a region of a wide range image that is displayed in the case where the operation status condition has been established. More specifically, a wide range image is an image depicting a region from the front side to the rear side of the vehicle 100, and is an image of a region within the ranges of the angles of view R1 and L1, similar to the images captured by the right imaging unit 11 and the left imaging unit 12. The display region processing unit 17 generates, as wide range images, images of regions that are the same as the images of the angles of view R1 and L1 captured by the right imaging unit 11 and the left imaging unit 12.

In the vehicle periphery display device 10 according to the present embodiment 1, narrow range images depicting the rear side of the vehicle 100 are displayed on the right display unit 14 and the left display unit 15 in a case where a direction is not indicated by means of the direction indicator 16. These narrow range images allow the driver to view a region that corresponds to that of a conventional general door mirror, and can be viewed without the driver experiencing a sense of discomfort.

Furthermore, in a case where a direction is indicated by the direction indicator 16, wide range images depicting regions from the front side to the rear side of the vehicle 100 are displayed on the right display unit 14 and the left display unit 15. These wide range image make is possible for the driver to view a front region that becomes a blind spot due to a front pillar when turning right or left, and for the driver to view a side region that becomes a blind spot due to a conventional door mirror when changing lanes.

In addition, in the vehicle periphery display device 10 according to the present embodiment 1, the right imaging unit 11 and the left imaging unit 12 which have wide angles of view are used, and narrow range images and wide range images are generated by varying the display ranges of captured images by means of the image processing carried out by the display region processing unit 17. It is thereby possible to prevent an increase in the number of cameras for imaging. Furthermore, since narrow range images and wide range images are switched and displayed in accordance with the operation status condition, and two different images are not displayed on one screen, the driver does not experience a sense of discomfort.

Note that, in the aforementioned description, in the case where the operation status condition has been established (in the case where a direction has been indicated by the direction indicator 16), the display images in the right display unit 14 and the left display unit 15 are switched to wide range images. However, the present disclosure is not restricted thereto, and switching to a wide range image may be implemented for only one of the right display unit 14 and the left display unit 15. More specifically, a configuration may be adopted in which only the right display unit 14 is switched to a wide range image in a case where the right direction has been indicated, and only the left display unit 15 is switched to a wide range image in a case where the left direction has been indicated.

### Embodiment 2

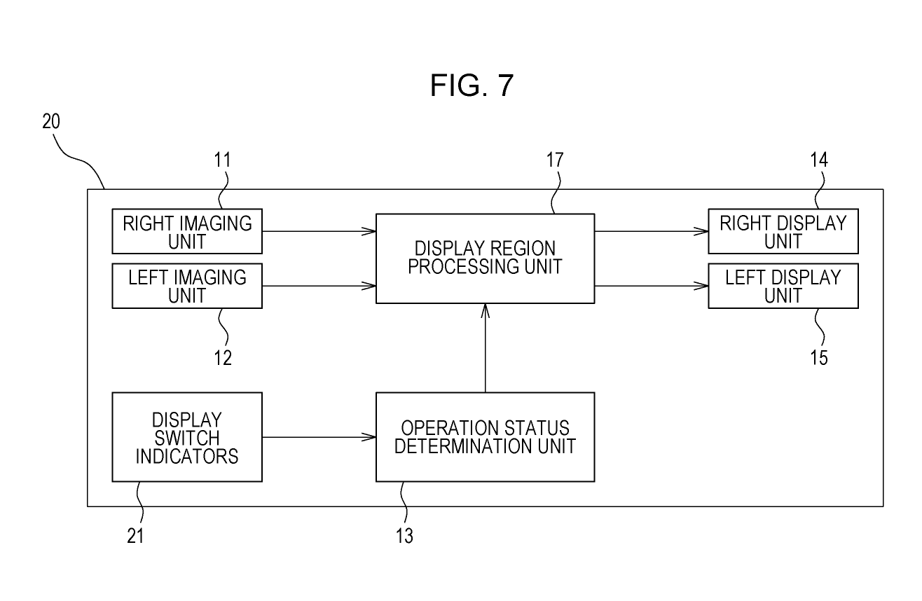

FIG. 7 is a block diagram depicting a schematic configuration of a vehicle periphery display device 20 according to the present embodiment 2. The vehicle periphery display device 20 includes the right imaging unit 11, the left imaging unit 12, the operation status determination unit 13, the right display unit 14, the left display unit 15, display switching indicators 21, and the display region processing unit 17, or the like. More specifically, the vehicle periphery display device 20 depicted in FIG. 7 is a configuration that includes the display switching indicators 21 instead of the direction indicator 16 in the vehicle periphery display device 10 depicted in FIG. 1. Hereinafter, constituent elements similar to those in embodiment 1 are denoted by the same reference numbers, and descriptions will be given focusing on the portions that are different.

The vehicle periphery display device 20 according to the present embodiment 2 is different from embodiment 1 in that, when the display image of the right display unit 14 or the left display unit 15 is switched to a wide range image, it is made possible for the switching to be carried out at a timing desired by the driver rather than in conjunction with the direction indicator 16. More specifically, in the vehicle periphery display device 20, it is possible for the display image of the right display unit 14 or the left display unit 15 to be switched to a wide range image at an arbitrary timing by the driver operating the display switching indicators 21.

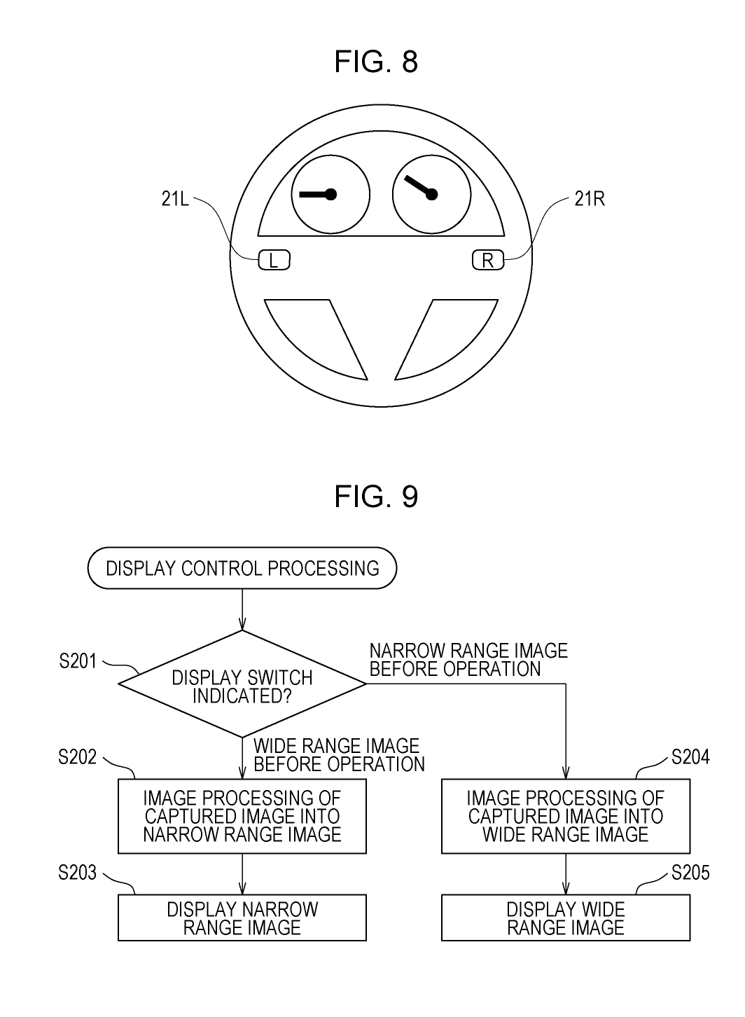

FIG. 8 is a drawing depicting an example of arrangement positions for the display switching indicators inside the vehicle interior. As depicted in FIG. 8, the display switching indicators 21 include a right switch 21R and a left switch 21L, and it is possible to switch between the display of a narrow range image and a wide range image in the right display unit 14 or the left display unit 15 by the driver operating the right switch 21R or the left switch 21L. More specifically, if the driver operates the right switch 21R while the right display unit 14 is displaying a narrow range image, the operation status condition in the right display unit 14 is considered to have been established, and the right display unit 14 is switched to a wide range image. Furthermore, if the driver once again operates the right switch 21R while the right display unit 14 is displaying the wide range image, the operation status condition in the right display unit 14 is considered to have been canceled, and the right display unit 14 is switched to a narrow range image. Similar display switching control is carried out by the left switch 21L in relation to the left display unit 15.

Note that FIG. 8 exemplifies a case where the display switching indicators 21 (the right switch 21R and the left switch 21L) are installed in a steering wheel; however, the arrangement position of the display switching indicators 21 is not particularly restricted, and the display switching indicators 21 may be disposed on the surface of the dashboard in the vicinity of the driver's seat, for example.

FIG. 9 is a flowchart depicting display control processing for a captured image in the vehicle periphery display device 20 of the present embodiment 2. Note that the display control processing depicted in FIG. 9 can be carried out independently in each of the right side and the left side.

In S201 in FIG. 9, in a case where a display switching indicator 21 has been operated by the driver, it is determined whether or not this operation causes the specific operation status condition to be established or causes the operation status condition to be canceled. At such time, if the display prior to the operation is a wide range image, it is determined that the specific operation status condition has been canceled, and processing transitions to S202. However, if the display prior to the operation is a narrow range image, it is determined that the specific operation status condition has been established, and processing transitions to S204.

In a case where the operation status condition has been canceled by operating a display switching indicator 21, the display is switched from a wide range image to a narrow range image. At such time, the display region processing unit 17 carries out image processing that generates a narrow range image from a captured image that is input (S202). A display unit (the right display unit 14 or the left display unit 15) then displays the narrow range image generated by the display region processing unit 17 (S203).

In a case where the operation status condition has been established by operating a display switching indicator 21, the display is switched from a narrow range image to a wide range image. At such time, the display region processing unit 17 carries out image processing that generates a wide range image from a captured image that is input (S204). A display unit (the right display unit 14 or the left display unit 15) then displays the wide range image generated by the display region processing unit 17 (S205).

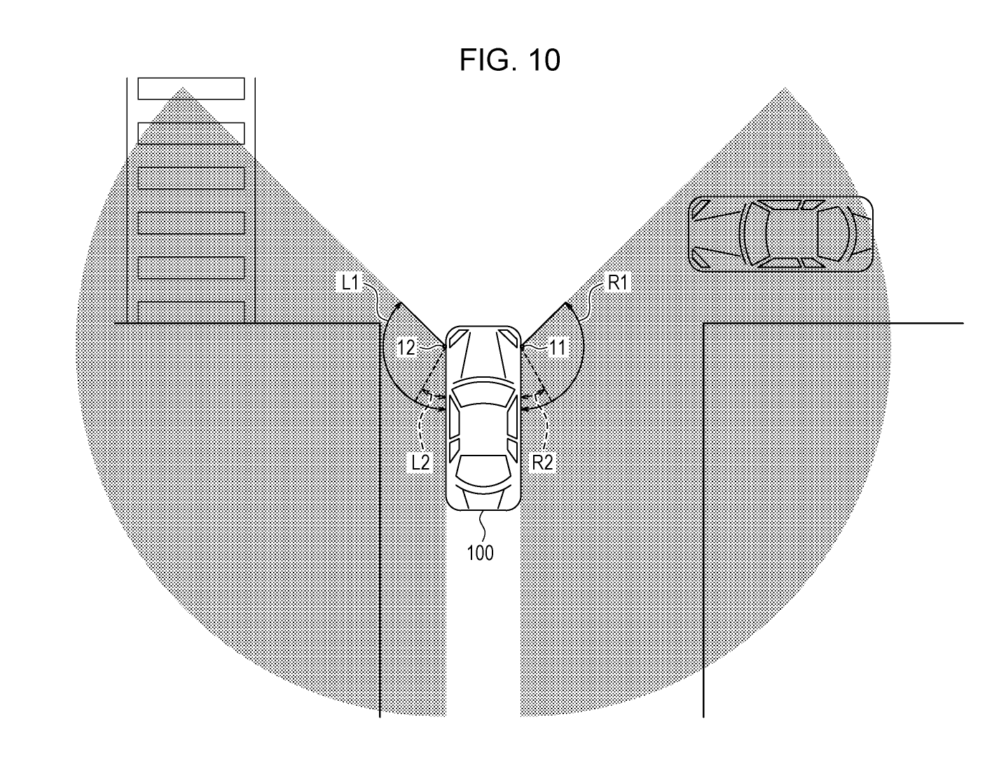

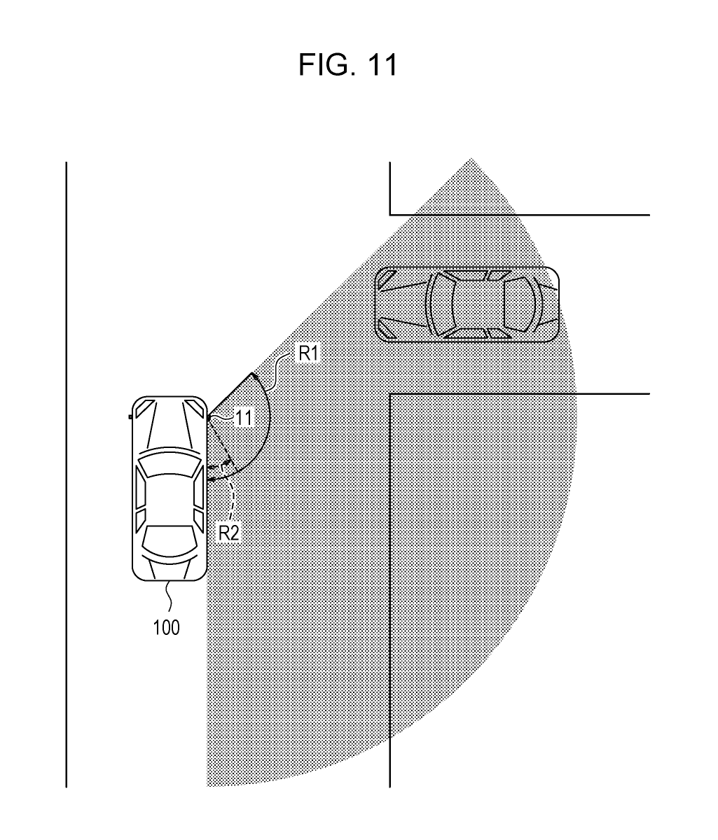

In the vehicle periphery display device 20 according to the present embodiment 2, it is possible for the display image of the right display unit 14 or the left display unit 15 to be switched to a wide range image at an arbitrary timing by the driver operating a display switching indicator 21. Thus, as depicted in FIGS. 10 and 11, at an intersection or the like where visibility is poor, it becomes possible for the driver to confirm the front left side and the front right side by means of wide range images.

### Embodiment 3

In the vehicle periphery display device 20 according to the aforementioned embodiment 2, switching between a narrow range image and a wide range image is carried out whenever the driver operates a display switching indicator 21; however, a configuration may be adopted in which the operation of a display switching indicator 21 is used only for switching from a narrow range image to a wide range image. In this case, after switching to a wide range image has been carried out by operating a display switching indicator 21, the display may return to a narrow range image after a predetermined time (for example, after 5 seconds) has elapsed.

In the description in the aforementioned embodiments 1 to 3, examples are given in which an imaging unit and a display unit are disposed on both the left and right sides; however, the present disclosure is not restricted thereto, and a configuration may be adopted in which an imaging unit and a display unit are disposed at only either one of the right or the left. In this case, it is sufficient for a conventional door mirror to be disposed at the side at which an imaging unit and a display unit is not disposed.

Furthermore, in the description in the aforementioned embodiments 1 to 3, the angle of view of a captured image is the same as the angles of view R1 and L1 of a wide range image; however, the present disclosure is not restricted thereto, and a configuration may be adopted in which the angle of view of a captured image is wider than the angles of view R1 and L1 of a wide range image. However, by making the angle of view of a captured image to be the same as the angles of view R1 and L1 of a wide range image (making a wide range image to be a region that corresponds to the entirety of a captured image), it is possible to reduce the load of the display region processing unit 17 when a wide range image is to be generated.

The embodiments disclosed herein are exemplary in all respects and do not constitute a basis for a limiting interpretation. Accordingly, the technical scope of the present disclosure is not to be interpreted according to only the aforementioned embodiments, and is defined based on the descriptions in the claims. Furthermore, all modifications within the meaning and range of equivalency of the claims are included.

The present disclosure contains subject matter related to that disclosed in Japanese Priority Patent Application JP 2018-082189 filed in the Japan Patent Office on Apr. 23, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A vehicle periphery display device that is provided in a vehicle and comprises:
an imaging unit that is disposed on at least either one of a left and right side surface of the vehicle, and acquires a captured image of a front side to a rear side of the vehicle;
an operation status determination unit that determines an operation status of the vehicle;
a display region processing unit that generates, from the captured image, a display image having a display region that corresponds to a determination result produced by the operation status determination unit; and
a display unit that displays the display image,
wherein the display region processing unit implements a region of the display image that is generated in a case where a predetermined operation status condition has been established, as a region having an angle of view that is wider than that of the region of the display image that is generated in a case where the operation status condition has not been established.

2. The vehicle periphery display device according to claim 1,
wherein the display region processing unit generates the display image generated in the case where the operation status condition has been established, as a wide range image of the front side to the rear side of the vehicle, and generates the display image generated in the case where the operation status condition has not been established, as a narrow range image corresponding to a region at the rear side of the vehicle.

3. The vehicle periphery display device according to claim 2,
wherein the display region processing unit generates the wide range image as an image of a region which corresponds to an entirety of the captured image, and generates the narrow range image as an image of a region for which a portion of the captured image is cut out.

4. The vehicle periphery display device according to claim 1,
wherein the operation status determination unit determines that the operation status condition has been established in a case where a direction indicator of the vehicle has been operated.

5. The vehicle periphery display device according to claim 1,
wherein the vehicle periphery display device has a display switching indicator that switches the display image displayed on the display unit, and
the operation status determination unit determines that the operation status condition has been established in a case where the display switching indicator has been operated.

6. The vehicle periphery display device according to claim 1,
wherein the imaging unit is arranged at a front wheel fender position of the vehicle or in front of the front wheel fender position.
